(19) United States
(12) Patent Application Publication
(10) Pub. No.: US 2016/0176725 A1
(43) Pub. Date: Jun. 23, 2016

(54) AMORPHOUS ALUMINA SILICATE MIXTURE AND METHOD

(71) Applicant: Lewis Scott Niles, Whitefield, NH (US)

(72) Inventor: Lewis Scott Niles, Whitefield, NH (US)

(21) Appl. No.: 14/317,503

(22) Filed: Jun. 27, 2014

Related U.S. Application Data
(60) Provisional application No. 61/839,927, filed on Jun. 27, 2013.

(51) Int. Cl. C02F 1/28; B01J 20/28; B01J 20/16

(52) U.S. Cl. CPC C02F 1/281; B01J 20/16; B01J 20/28016

(57) ABSTRACT

A method of removing contaminants from an aqueous solution includes providing a mixture of amorphous alumina silicate granules having a plurality of predefined sieve grades, where the mixture has enhanced molecular encapsulation compared to alumina silicate granules of a single sieve grade. An aqueous solution containing contaminant molecules is passed through the mixture of amorphous alumina silicate. The mixture of amorphous alumina silicate is disposed of, where the contaminant molecules from the aqueous solution are encapsulated within a plurality of pores of the mixture and ionically bonded to the amorphous alumina silicate.

### BACKGROUND OF THE INVENTION

1. Field of the Invention

The present invention relates generally to compositions of matter for mitigating hazardous waste spills. More specifically, the present invention relates to a mixture of amorphous alumina silicate and methods of use.

2. Description of the Prior Art

The building trades, disaster relief, and environmental protection industries have used a material for spill control for decades. The material of choice for spill control is commonly known as pumice, or amorphous alumina silicate. Pumice is a form of volcanic glass. Pumice is a mineral formed as a result of violent volcanic eruptions where gasses are forced to mix with the molten magma in the volcanic chamber prior to eruption. The magma-gas mixture then expands millions of times as the molten material blasts from the volcano. This explosive action releases the trapped gaseous molecules and instantly creates billions of micro-porous cavities in crystals of the pumice as it rapidly cools. Amorphous alumina silicate is a zeolite, which is a class of microporous, aluminosilicate minerals commonly used as commercial adsorbents. Zeolites are the aluminosilicate members of the family of microporous solids known as “molecular sieves.” The term molecular sieve refers to the ability of these solids to selectively sort molecules by using a size exclusion process. Separation is due to a very regular pore structure of molecular dimensions, where the maximum size of the molecular or ionic species that can enter the pores of a zeolite is controlled by the dimensions of the channels. This unique property enables the mineral to divide and sort molecules according to size. Thus, the tiny molecules of noble gasses, hydrogen, and oxygen are released harmlessly to the atmosphere while larger molecules such as carbons are trapped in the molecular pores of the mineral. Further, an ionic process bonds the carbon molecules to the inside of the porous minerals forever.

This sorting and subsequent ionic bonding allows amorphous alumina silicate to encapsulate hydrocarbons such as petro-carbons including, but not limited to, oils, fuels, glycols, thinners, inks, paints, solvents, greases and acids such as sulfuric and hydrochloric acid. Zeolites are known to encapsulate chlorines and other chemical molecules.

In the natural gas industry, hydraulic fracturing (or “fracking”) is a method used to extract natural gas from shale and coal formations located thousands of feet below the surface. Large volumes (˜three million gallons per well) of water, proppants (e.g., sand), and chemical additives are pumped at high pressure into the well to expand formations and release gas trapped there. Chemical additives include methanol, ethylene glycol, 2-butoxyethanol, hydrochloric and acetic acids, polyacrylamide, guar gum, sodium chloride (table salt), borate salts, sodium carbonate, and potassium carbonate. For example, fracking effluent (or “flowback water”) from hydraulic fracturing in Pennsylvania was a sludge found to be strongly acidic (pH of 2.5-4) and contain high concentrations of barium (˜500-15,000 ppm), strontium (˜5000 ppm), lead (˜25 ppb), manganese (˜9 ppm), magnesium (˜2500 ppm), calcium (˜30,000 ppm), and iron (˜100 ppm). For reference, 2009 EPA guidelines designate 2 ppm as the maximum concentration of barium for drinking water. Due to its toxicity to freshwater organisms, fracking effluent is considered hazardous waste and currently receives heightened scrutiny for concerns about groundwater and other environmental contamination.

In addition to spills involving petrochemicals and contamination from hydraulic fracturing, leaks and spills from nuclear power plants and other nuclear industries have contaminated water supplies with radioactive isotopes. Examples of such leaks include destruction of the Fukushima Daiichi nuclear power plant in Japan and leaking storage tanks at the Hanford nuclear facility in Washington. Current practice has been to collect short-lived radioactive waste and store it at a waste site. Low-level and some intermediated-level wastes are disposed of by burying at near-surface depths. High-level wastes are disposed of using deep burial or undergo transmutation.

Further, municipal wastewater treatment facilities process millions of gallons of water daily. Public water treatment systems successively recycle the same water in the course of hours or days. As a result, drinking water now contains pharmaceuticals, such as medications, legal or illegal drugs, vitamins, hormones, and other dietary supplements in in higher and higher concentrations. Due to the failure of the water treatment systems to properly remove these contaminants, the concentration of pharmaceuticals in drinking water continues to increase due to the daily addition of more pharmaceutical compounds from flushing of unused prescriptions, human waste containing the drugs and supplements, the introduction of hospital and mortuary waste (e.g., bodily fluids), and many other forms of bio-waste. This inability or ineffectiveness in removing pharmaceuticals from our water supply has created a concentrated “soup” of harmful ingredients which are having a significant impact on the overall health and well-being of the global population.

### SUMMARY OF THE INVENTION

Existing spill control and filtration materials do not contain the quantity of waste as promised on packaging. Single-grind formulations contain one sieve grade of alumina silicate granules. Larger particles fail to provide sufficient surface area to rapidly contain contaminant molecules. Smaller particles have not been used for spill clean-up because they become a sludge when applied to spills or to an aqueous solution. As a result, much more spill control material must be used, which is costly and inefficient. Also, because existing materials fail to bind all of the spilled liquid, the spilled liquid is present on the outside of the spill control material. Therefore, the spill control material must be handled as bulky, hazardous waste. This makes available spill control materials even more expensive to use.

For other contaminants, filters fail to bind contaminants, but merely act as a physical barrier to trap contaminants. As a result, water filters fail to effectively remove small contaminant molecules and ions from water. Water filters also have a short lifetime and have high replacement costs. Thus, wastewater treatment and purification can be greatly improved. The present invention is useful for water purification, decontamination, and desalination due to its ability to separate molecules and ions using size exclusion and also due to its ability to ionically bind ions and molecules in pores.

For water contaminated with radioactive species, current approaches do not separate the radioactive material from the water, but instead focus on disposing of large volumes of contaminated water. This approach is not only expensive and inefficient, but it also fails to remove the radioactive species from the water so that disposal efforts focus on the radioactive species rather than the overwhelmingly large component of water.

Additionally, beginning in 2014, the US Environmental Protection Agency (EPA) will regulate disposal of wastewater used in natural gas extraction from coal bed methane and shale gas wells. Regulations will address disposal and treatment of wastewater or fracking effluent from these wells in addition to imposing limitations on reuse of fracking water. Because of the large amount of water used in each well, fracking water is expensive to purchase and expensive to dispose of.

Regarding municipal wastewater, despite existing regulations and processes for treating and recycling waste water in municipal water treatment plants, no effective or standard provisions are directed to removal of pharmaceuticals, such as medications, legal or illegal drugs, vitamins, hormones, and other dietary supplements. These substances pollute the water that we ingest every day in the belief that it is safe a healthy to consume. Humans are slowly being poisoned by that which is supposed to be the life-giving resource we cannot survive without. With only three percent of the world's water being fresh and potable, the world is fast approaching a time when clean water is worth more than any other substance on earth.

Considering the foregoing, what is needed is a method to more effectively remove contaminants from wastewater. More specifically, a need exists for having improved performance to separate and bind contaminants from wastewater, such as in the fields of natural gas extraction, nuclear energy, desalination, and municipal wastewater purification. What is also needed is a spill control material useful for soil remediation.

It is an object of the present invention to reduce the quantity of waste to be disposed when using a contaminant clean-up material.

It is another object of the present invention to separate contaminants from water using the material's size exclusion properties.

It is another object of the present invention to ionically bind contaminants to the contaminant clean-up material.

The present invention achieves these and other objects by providing a method of water treatment and a mixture of amorphous alumina silicate that separates contaminants and ionically binds the contaminant molecules. The present invention is a paradigm shift product because a way has been found to enhance the rate and quantity of contaminant encapsulation. Using granule size dispersion, embodiments of the present invention are thousands of times more effective than the single grind versions of alumina silicate currently available on the market. This is a surprising and an unexpected result.

In one embodiment of the present invention, a method of removing contaminants from an aqueous solution includes providing a mixture of amorphous alumina silicate granules having a plurality of predefined sieve grades, where the mixture has enhanced molecular encapsulation compared to alumina silicate granules of a single sieve grade. Through the mixture of amorphous alumina silicate is passed an aqueous solution containing contaminant molecules. The mixture of amorphous alumina silicate is disposed of, where the contaminant molecules from the aqueous solution are encapsulated within a plurality of pores of the mixture and ionically bonded to the amorphous alumina silicate.

In another embodiment of the method, the mixture comprises sieve grade #3 granules and sieve grade #0 granules. In another embodiment of the method, the sieve grade #3 granules and sieve grade #0 granules are mixed in substantially equal parts by weight.

In another embodiment, the method includes the steps of providing a predefined quantity by weight of hydrolyzed lime and/or providing a predefined quantity by weight of borax. In another embodiment of the method, the predefined quantity of hydrolyzed lime is equal to about two percent by weight. In another embodiment of the method, the predefined quantity of borax is equal to about two percent by weight.

In another embodiment of the method, the mixture further comprises an equal part by weight of a second mixture of amorphous alumina silicate granules, where the second mixture includes sieve grade #8 granules, sieve grade #6 granules, and sieve grade #4 granules. In another embodiment, the second mixture has equal parts by weight of sieve grade #8 granules, sieve grade #6 granules, and sieve grade #4 granules.

In another embodiment of the method, the plurality of predefined sieve grades based on the US Mesh series and is an aggregate blend of sieve mesh 20 granules, sieve mesh 30 granules, sieve mesh 60 granules, sieve mesh 140 granules, sieve mesh 200 granules, and sieve mesh 325 granules.

In another embodiment of the method, the contaminant molecules are selected from the group consisting of a salt, a radioisotope, an acid, a metal, a hydrocarbon, and an organic molecule.

In another embodiment of the method, the aqueous solution is fracking effluent, wastewater containing radioactive species, saltwater, groundwater runoff, or municipal wastewater.

### BRIEF DESCRIPTION OF THE DRAWINGS

FIG. 1 is a flow chart showing steps of one embodiment of a method of the present invention.

### DETAILED DESCRIPTION OF THE PREFERRED EMBODIMENT

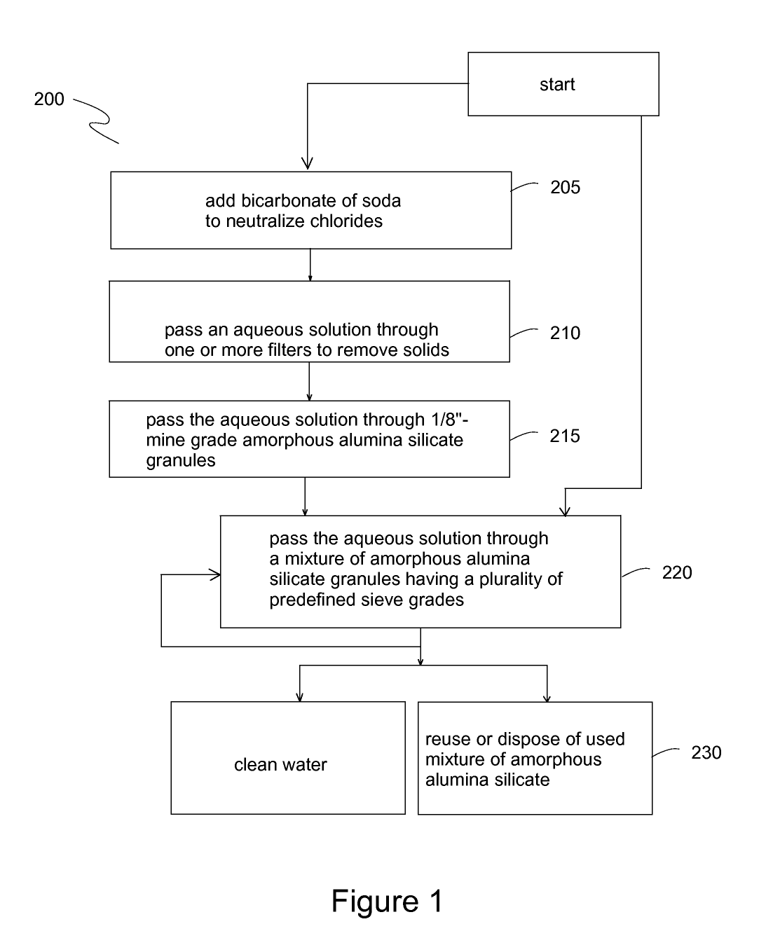

Embodiments of the present invention are discussed with reference to FIG. 1. U.S. provisional patent application Ser. No. 61/186,914 and filed Jun. 15, 2009, and U.S. provisional patent application Ser. No. 61/235,721 and filed Aug. 21, 2009, are incorporated herein by reference.

Amorphous alumina silicate is a material that lacks a crystalline structure, has a positive ionic charge of 8+ to 10+, and is glass-like in its physical properties. Amorphous alumina silicate removes contaminants by two primary mechanisms. First, alumina silicate encapsulates molecules in pores based on size exclusion. Gases such as H₂ and O₂ and other ions and molecules are small enough to freely pass through the material while larger ions or molecules are trapped in pores. Second, once encapsulated, alumina silicate ionically binds molecules due to its positive charge. Although scientific discussions offer possible explanations, the mechanism is not known to explain why water appears to pass through the amorphous alumina silicate unaffected and without becoming ionically bonded while other ions.

By selecting the particle sizes in a mixture of amorphous alumina silicate, embodiments of the present invention greatly increase the opportunity for the granule surfaces to contact and ionically bind contaminant particles introduced between two mineral molecules. The result is greatly increased encapsulation rate of hydrocarbons and other contaminants, making the amorphous alumina silicate of the present invention far superior to any other spill control material. Because trapped organic molecules or other contaminant molecules are ionically bonded, they are not released from inside the mineral's micro-porous structure. Therefore, except in the case of radioactive waste, the used alumina silicate can then be directly disposed in a landfill with no further hazardous waste mitigation. This eliminates a myriad of problems and further costs common to other types of clean-up materials, like contaminant seepage from oil-soaked spill-control material.

Several effective mixtures provide rapid encapsulation of contaminant molecules by encapsulating the contaminant molecules within pores of the amorphous alumina silicate and ionically bonding the contaminant molecules to the amorphous alumina silicate. Notably, depending on the viscosity of the contaminated material, mixtures of amorphous alumina silicate of the present invention can be reused up to six times before being directly disposed as non-hazardous waste. This is a tremendous value-added characteristic unique to the present invention.

Using a sieve number based on round diamonds, amorphous alumina silicate particles of a given sieve number have sizes as shown below in Table 1, which shows the particle size in mm, the sieve number. Using this sieve number system, granules of sieve grade #0 have a size of 1.10 mm and granules of sieve grade #3 have a size of 1.35 mm. Each granule is an agglomerate of particles of sizes between about five microns (5 μm) and about sixty-six microns (66 μm).

TABLE 1
Sieve number and corresponding particle
sizes based on a round diamond

| Size (mm) | Sieve # | Size (mm) | Sieve # |
|---|---|---|---|
| 0.80 mm | +0000 | 2.2 mm | +8.50 |
| 0.90 mm | +000 | | +8.75 |
| 1.00 mm | +95 | 2.3 mm | +9.0 |
| 1.05 mm | +00 | | +9.25 |
| | +105 | 2.4 mm | +9.50 |
| 1.10 mm | +0 | | +9.75 |
| | +112.5 | 2.5 mm | +10.0 |
| 1.15 mm | +1.0 | | +10.25 |
| | +1.25 | 2.6 mm | +10.50 |
| 1.20 mm | +1.50 | | +10.75 |
| | +1.75 | 2.7 mm | +11.0 |
| 1.25 mm | +2.0 | | +11.25 |
| | +2.25 | 2.8 mm | +11.50 |
| 1.30 mm | +2.50 | | +11.75 |
| | +2.75 | 2.9 mm | +12.0 |
| 1.35 mm | +3.0 | | +12.25 |
| | +3.25 | 3.0 mm | +12.50 |
| 1.40 mm | +3.50 | | +12.75 |
| | +3.75 | 3.1 mm | +13.0 |
| 1.45 mm | +4.0 | | +13.25 |
| | +4.25 | 3.2 mm | +13.50 |
| 1.50 mm | +4.50 | | +13.75 |
| | +4.75 | 3.3 mm | +14.0 |
| 1.55 mm | +5.0 | | +14.25 |
| | +5.25 | 3.4 mm | +14.50 |
| 1.60 mm | +5.50 | | +14.75 |
| | +5.75 | 3.5 mm | +15.0 |
| 1.70 mm | +6.0 | 3.6 mm | +15.5 |
| | +6.25 | 3.7 mm | +16.0 |
| 1.80 mm | +6.50 | 3.8 mm | +16.5 |
| | +6.75 | 3.9 mm | +17.0 |
| 1.90 mm | +7.0 | 4.0 mm | +17.5 |
| | +7.25 | 4.1 mm | +18.0 |
| 2.00 mm | +7.50 | 4.2 mm | +18.5 |
| | +7.75 | 4.3 mm | +19.0 |
| 2.10 mm | +8.0 | 4.4 mm | +19.5 |
| | +8.25 | 4.5 mm | +20.0 |

Table 2 shows particle sizes for US Mesh numbers, which identifies sieve screens in meshes per inch for square openings. For example, US mesh no. 6 has an opening of 3.36 mm. Therefore, granules of US Mesh no. 6 are larger than 3.36 mm, but less than 4.00 mm, which is the size of openings in the US Mesh no. 5 sieve.

TABLE 2
particle sizes related to US Mesh number

| | |
|---|---|
| Sieve Designation | Nominal Sieve Opening |

| | | | | |
|---|---|---|---|---|
| Standard | US Mesh | Inches | mm | Microns |

| | | | | | | |
|---|---|---|---|---|---|---|
| 25.4 | mm | 1 | in. | 1.00 | 25.4 | 25400 |
| 22.6 | mm | ⅞ | in. | 0.875 | 22.6 | 22600 |
| 19.0 | mm | ¾ | in. | 0.750 | 19.0 | 19000 |
| 16.0 | mm | ⅝ | in. | 0.625 | 16.0 | 16000 |
| 13.5 | mm | 0.530 | in. | 0.530 | 13.5 | 13500 |
| 12.7 | mm | ½ | in. | 0.500 | 12.7 | 12700 |
| 11.2 | mm | 7/16 | in. | 0.438 | 11.2 | 11200 |
| 9.51 | mm | ⅜ | in. | 0.375 | 9.51 | 9510 |
| 8.00 | mm | 5/16 | in. | 0.312 | 8.00 | 8000 |
| 6.73 | mm | 0.265 | in. | 0.265 | 6.73 | 6730 |
| 6.35 | mm | ¼ | in. | 0.250 | 6.35 | 6350 |
| 5.66 | mm | No. | 3½ | 0.223 | 5.66 | 5660 |
| 4.76 | mm | No. | 4 | 0.187 | 4.76 | 4760 |
| 4.00 | mm | No. | 5 | 0.157 | 4.00 | 4000 |
| 3.36 | mm | No. | 6 | 0.132 | 3.36 | 3360 |
| 2.83 | mm | No. | 7 | 0.111 | 2.83 | 2830 |
| 2.38 | mm | No. | 8 | 0.0937 | 2.38 | 2880 |
| 2.00 | mm | No. | 10 | 0.0787 | 2.00 | 2000 |
| 1.68 | mm | No. | 12 | 0.0661 | 1.68 | 1680 |
| 1.41 | mm | No. | 14 | 0.0555 | 1.41 | 1410 |
| 1.19 | mm | No. | 16 | 0.0496 | 1.19 | 1190 |
| 1.00 | mm | No. | 18 | 0.0394 | 1.00 | 1000 |
| 841 | μm | No. | 20 | 0.0331 | 0.841 | 841 |
| 707 | μm | No. | 25 | 0.0278 | 0.707 | 707 |
| 595 | μm | No. | 30 | 0.0234 | 0.595 | 595 |
| 500 | μm | No. | 35 | 0.0197 | 0.500 | 500 |
| 420 | μm | No. | 40 | 0.0165 | 0.420 | 420 |
| 345 | μm | No. | 45 | 0.0139 | 0.354 | 354 |
| 297 | μm | No. | 50 | 0.0117 | 0.297 | 297 |
| 250 | μm | No. | 60 | 0.0098 | 0.250 | 250 |
| 210 | μm | No. | 70 | 0.0083 | 0.210 | 210 |
| 177 | μm | No. | 80 | 0.0070 | 0.177 | 177 |
| 149 | μm | No. | 100 | 0.0059 | 0.149 | 149 |
| 125 | μm | No. | 120 | 0.0049 | 0.125 | 125 |
| 105 | μm | No. | 140 | 0.0041 | 0.105 | 105 |
| 88 | μm | No. | 170 | 0.0035 | 0.088 | 88 |
| 74 | μm | No. | 200 | 0.0029 | 0.074 | 74 |
| 63 | μm | No. | 230 | 0.0025 | 0.063 | 63 |
| 53 | μm | No. | 270 | 0.0021 | 0.053 | 53 |
| 44 | μm | No. | 325 | 0.0017 | 0.044 | 44 |
| 37 | μm | No. | 400 | 0.0015 | 0.037 | 37 |

### Example 1

In this example, a first mixture has amorphous alumina silicate granules with each granule being an agglomeration of particles between five microns and sixty-six microns. Based on Table 1 above, the first mixture is prepared by combining sieve grade #3 granules (size 1.35 mm) and sieve grade #0 granules (size 1.10 mm) in a ratio of one to one by weight. The first mixture is used as a spill control material.

The first mixture is a granule-based product that provides instant molecular encapsulation for all types of hydrocarbon spills and other contaminants. It is ideal for industrial uses and works effectively on all large and small spills, such as machine oils and lubricants, coolants (including glycol and non-glycol types), acids, fuels (e.g., gasoline, racing fuel, aviation fuel), oil, diesel, gasoline, kerosene, thinners, lacquers, solvents, inks, latex and oil-based paints, and the like. It can be applied before a spill occurs or applied to an existing spill with equally satisfactory results. Only minor agitation is required for maximum effectiveness. A stiff broom or squeegee may optionally be used to provide the agitation. Clean-up is simple with conventional broom and dustpan or vacuum methods. When used as a spill control material, the first mixture does not leave any oil residue on the affected surface and, in most cases, the treated surface is actually cleaner than before the spill occurred.

An unexpected but very significant quality of the present invention is its ability to control the flash point of fuel spills. The flash point occurs when a fuel spill releases vapors which can ignite explosively. When broadcast onto a liquid fuel spill, the first mixture instantly begins to encapsulate the liquid that is releasing the vapors. This action effectively slows down the vaporization rate and substantially reduces the risk of explosion to a minimal level. Consequently, its use is ideal at accident scenes where fuels are often spilled. The spilled fuel causes dangerous vapors to threaten the lives of victims and response teams like firemen, police and emergency medical technicians.

The first mixture may optionally be further modified in granulation or mineral composition and used effectively for many other uses. The following examples are some of these modified compositions.

### Example 2

In this example, the first mixture described above for Example 1 is blended with a two percent (2%) inclusion of hydrolyzed lime and/or a two percent (2%) inclusion of borax by weight, resulting in a second mixture. The second mixture is designed to mitigate bio-hazard spills such as blood, urine, vomit and other bodily fluids. It is extremely effective for clean-up of septage spills and other septic applications. The second mixture brings the pH level of the bio-hazard spill to within acceptable standards while breaking down and encapsulating the solids for direct disposal into a landfill or for spreading on approved septage spread sites. Its uses include hospital and mortuary applications, accident scenes, flooded water treatment centers, septic overflows, municipal waste water, and pipeline projects. It is also useful for all types of household spills including milk, cooking oils and grease, soaps and cleaning agents, ammonia, and bleach. The second mixture is far superior to other conventional means of spill control and mitigation for biohazard spills.

### Example 3

A third mixture of amorphous alumina silicate includes one part by weight of each of sieve grade #8 granules (size 2.10 mm), sieve grade #6 granules (size 1.70 mm), and sieve grade #4 granules (size 1.45 mm) using sizes shown above in Table 1. Added to one part by weight of the third mixture is one part by weight of first mixture of Example 1. The combination of first mixture and third mixture can be broadcast onto beach lines and shorelines when a floating spill threatens the environment. The third mixture interdicts heavy oil. First mixture is then added to clean up oil residuals. When used in an amount sufficient to match the size of the threat, the combination of third mixture and first mixture will encapsulate most of the waterborne contaminants before they can cause major or irreparable harm to coastal shorelines and beaches. The mixture can then be easily collected and disposed directly into a landfill with no further treatment or mitigation. The use of the combination of first mixture and third mixture has the potential for saving untold millions of dollars in clean-up efforts and associated costs, and will leave the environment substantially intact.

### Example 4

This example uses third mixture and first described above in Example 3 in a two-part process for use on water-borne spills. The first part of the process involves broadcasting the third mixture of amorphous alumina silicate granules mixed in equal parts by weight of sieve grade #8 granules (size 2.10 mm), sieve grade #6 granules (size 1.70 mm), and sieve grade #4 granules (size 1.45 mm) onto the surface of the water-borne spill. The third mixture floats on the surface of the water or water-borne spill. Its function is to control and stop the spread of the slick and to begin the encapsulation process immediately. The floating mat of granules forms a scab over the spill, thus helping to limit the spread of the slick. The third mixture, along with the slick, is then skimmed from the surface of the water. As the used third mixture of amorphous alumina silicate is collected, it is mixed with first mixture described above for Example 1, which then completely encapsulates and mitigates any remaining oils or residues.

In certain applications, an appropriate amount of hydrocarbon-eating microbes can optionally be added to the amorphous alumina silicate to consume any film or “oil rainbow” left on the surface of the water. Naturally occurring microbes are present in all water sources that, when combined with wind and wave action, can consume a film over time. Adding microbes to the mixture speeds up the process considerably. After consuming the film, the majority of the microbes will die off leaving the environment in its natural state. Any remaining microbes will simply assimilate into the existing population without affecting the local eco-system.

Other applications such as the safe cleaning of shore and wading birds and sea life only add to the attractiveness of these environmentally responsible products. Other uses will become apparent as new circumstances present different challenges. Millions of gallons of oil are pumped and spilled every day and have become one of our most serious environmental challenges. As mindsets and governments move toward greener technologies, products embodying the present invention can safely, effectively and economically solve many of these problems.

### Example 5

In this example, a fourth mixture of amorphous alumina silicate is used to pull or remove oil stains from laundry. In this formulation, the fourth mixture has a Part A and a Part B. Part A is a mixture of sieve grade #3 granules and sieve grade #0 granules mixed in a ratio of one to one by weight, where each granule is an agglomeration of of particles with sizes between five and sixty-six microns. Part B is an aggregate blend of amorphous alumina silicate granules from US Mesh no. 20 to US Mesh no. 325. The size and weight distribution of particles of one such embodiment of Part B is shown in Table 3 below. Table 3 shows the US Mesh number, the weight of granules having a size of that US Mesh number, the weight percent of the total particles retained on a given sieve and the sieves above it, and the weight percent of particles passing through the sieve of the specified US Mesh number. Thus, one embodiment of Part B has 0.1 wt % of granules retained on the US Mesh no. 30 sieve. Similarly, 7.2 wt % of the particles are smaller than US Mesh no. 325 and pass through that sieve to the pan.

TABLE 3

| US | Accumulated | Accumulated | Percent |
|---|---|---|---|
| Mesh No. | Weight | Percent Retained | Passing |
| 20 | 0 | — | 100 |
| 30 | .04 | .06 | 99.9 |
| 60 | 13.7 | 21.6 | 78.4 |
| 140 | 40.2 | 63.3 | 36.7 |
| 200 | 50.9 | 80.2 | 19.8 |
| 325 | 58.9 | 92.8 | 7.2 |
| Pan | 635 | 100 | |

### Example 6

To address the problem of water contamination from pharmaceutical compounds, hydraulic fracturing, storm run-off and other sources, mixtures of the present invention are used to remove contaminants from water. Whether used in a system sized for household applications and that have commercially-available canisters, or used in industrial-sized systems that can process millions of gallons daily, the present invention addresses the world-wide need for a process to facilitate removal of these harmful constituents in an environmentally safe and responsible, sustainable, cost effective and commercially viable way.

Referring now to FIG. 1, amorphous alumina silicate is used in a method 200 to remove contaminants from an aqueous solution. A mixture of amorphous alumina silicate is used, where the mixture has a plurality of predefined sieve grades and exhibits enhanced molecule encapsulation compared to alumina silicate granules of a single sieve grade. The combination of different size alumina silicate particles provides a synergistic effect for the alumina silicate mixture that results in more effective size exclusion and/or ionic bonding to remove contaminant molecules, particles, and ions from the aqueous solution. Thus, smaller quantities of alumina silicate are required than in single-grind versions of the prior art.

In one embodiment of method 200, the first mixture (described in Example 1) is provided. First mixture has amorphous alumina silicate granules having sizes between five microns and sixty-six microns. First mixture is prepared by combining sieve grade #3 granules and sieve grade #0 granules in a ratio of one to one by weight in an aggregate blend. In other embodiments, the mixture is any of the mixtures discussed above.

In optional step 205, bicarbonate of soda is added to the aqueous solution to neutralize chlorides. Bicarbonate of soda binds chlorides, which then precipitate out of solution for easier removal in a pre-filtration step. Bicarbonate of soda is also useful to balance the pH of acidic solutions. Step 205 is preferably performed when aqueous solution is fracking effluent or salt water to be desalinated.

In optional step 210, the aqueous solution is pre-filtered by being passed through filters to remove solids. Step 210 captures easily-removed solids to prevent clogging and to maximize the life of the mixture, thus leaving ions, molecules, and small particles to be captured by the alumina silicate. In one embodiment, the filters are fabric filters that include a first filter with 5 μm openings, a second filter with 3 μm openings, and a third filter with 1 μm openings. In one embodiment, a series of twelve pre-filters is used. Step 210 is an optional, but preferred step in method 200.

In optional step 215, the aqueous solution is pre-filtered by being passed through ⅛″-mine grade granules of amorphous alumina silicate. In one embodiment, the mine grade granules are disposed in a tank or pool and mechanically agitated.

In step 220, the aqueous solution passes through the mixture to remove contaminant molecules. In one embodiment, a container, tank, or vessel is filled with the mixture, where the mixture takes the place of a solid filter medium. In step 220, water, hydrogen, oxygen, and other gases and small molecules pass through the pores of the alumina silicate granules and are not retained by the mixture. In contrast, contaminant molecules are encapsulated and ionically bonded within pores of the amorphous alumina silicate. Thus, after passing the aqueous solution through the mixture, contaminants are removed. Depending on the flow rate of the aqueous solution through the mixture and the quantity of the mixture, the aqueous solution optionally passes one or more additional times through the mixture to further deplete contaminant molecules. In one embodiment, 500 gallons of fracking effluent passes through 10 pounds of the mixture of amorphous alumina silicate granules.

In step 230, the aqueous solution is now clean water and the used mixture can be reused or disposed of as solid waste with the contaminant(s) being ionically bonded within pores of the amorphous alumina silicate.

In one embodiment, the aqueous solution is a fracking effluent. In another embodiment, the aqueous solution is salt water. In another embodiment, the aqueous solution is wastewater containing radioactive species, such as thorium, barium, strontium (e.g., strontium 90), boron, uranium, and/or cesium (e.g., cesium 137). In another embodiment, the aqueous solution is municipal wastewater or groundwater run-off containing oils, fuels, propylene glycol, and/or potassium acetate. In another embodiment. The aqueous solution contains pharmaceuticals, vitamins, and other ionic compounds.

Mixtures of the present invention are also useful for soil remediation. Soil remediation uses a mixture of alumina silicate granules known as ⅛″ mine grade, which is a mixture of all particle sizes up to and including particles at ⅛″ diameter.

The mixture of alumina silicate is broadcast onto contaminated soil. The alumina silicate mixture and the contaminated soil are optionally blended or agitated to more quickly bring contaminants in contact with the alumina silicate. With even very small quantities of moisture are present in the soil, contaminants are drawn into pores of the alumina silicate and become trapped. The used mixture of alumina silicate can remain with the soil or can be collected and used in other locations, such as being used as part of a road base. Having contained the contaminants, such as oil, in the pores of the alumina silicate, the contaminants are no longer capable of being carried to water supplies.

This mixture has proven to be highly effective in the solidification of hydrocarbon sludge found in in-ground and above ground fuel storage tanks, tankers, and sea going vessels. It is also effective as a solidifier for drill cuttings and production sludge in oil and natural gas drilling applications, as well as for stripping hydrocarbons from contaminated soils, such as are found at industrial sites, gas stations and fuel platforms. The mixture has been successfully used on spills where liquid diesel fuel is present on the impervious road surface as well as in the soil at the edge of the road where the spilled fuel had migrated. In all cases, the mixture has shown superior ability not only for controlling the liquid spill, but also for cleaning the surrounding areas of hydrocarbon contamination. These applications are easily extrapolated to effective use on Brownfield, Greenfield, and Super Fund sites.

Interestingly, and much to the benefit of the end user, in most cases, the used mixture is within the EPA's Beneficial Use Determination criteria as a feed stock material that can be used in road bed materials, asphalt, cold patch applications, and in the production of concrete products, such as retaining wall blocks, curbing, highway barriers, and sea wall construction. This unique advantage actually provides the end user with a return on investment rather than a large disposal bill to ship contaminated soil and used absorbent as hazardous waste.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

I claim:

1. A method of removing contaminants from an aqueous solution, comprising:
providing a mixture of amorphous alumina silicate granules having a plurality of predefined sieve grades, wherein the mixture has enhanced molecular encapsulation compared to alumina silicate granules of a single sieve grade;
passing through the mixture of amorphous alumina silicate an aqueous solution containing contaminant molecules; and
disposing of the mixture of amorphous alumina silicate, wherein the contaminant molecules from the aqueous solution are encapsulated within a plurality of pores of the mixture and ionically bonded to the amorphous alumina silicate.

2. The method of claim 1, wherein the mixture comprises sieve grade #3 granules and sieve grade #0 granules.

3. The method of claim 2, wherein the sieve grade #3 granules and sieve grade #0 granules are mixed in substantially equal parts by weight.

4. The method of claim 2, further comprising:
providing a predefined quantity by weight of hydrolyzed lime; and
providing a predefined quantity by weight of borax.

5. The method of claim 4, wherein the predefined quantity of hydrolyzed lime is equal to about two percent by weight.

6. The method of claim 4, wherein the predefined quantity of borax is equal to about two percent by weight.

7. The method of claim 2, wherein the mixture further comprises an-equal part by weight of a second mixture of amorphous alumina silicate granules, wherein the second mixture includes sieve grade #8 granules, sieve grade #6 granules, and sieve grade #4 granules.

8. The method of claim 7, wherein the second mixture has equal parts by weight of sieve grade #8 granules, sieve grade #6 granules, and sieve grade #4 granules.

9. The method of claim 1, wherein the plurality of predefined sieve grades is an aggregate blend of sieve mesh 20 granules, sieve mesh 30 granules, sieve mesh 60 granules, sieve mesh 140 granules, sieve mesh 200 granules, and sieve mesh 325 granules.

10. The method of claim 1, wherein the contaminant molecules are selected from the group consisting of a salt, a radioisotope, an acid, a metal, a hydrocarbon, and an organic molecule.

11. The method of claim 1, wherein the aqueous solution is selected from the group consisting of a fracking effluent, a wastewater containing radioactive species, and a saltwater, municipal wastewater containing pharmaceuticals, groundwater, and.
